(19) United States
(12) Patent Application Publication
(10) Pub. No.: US 2024/0070889 A1
(43) Pub. Date: Feb. 29, 2024

(54) DETECTING METHOD, DETECTING DEVICE, AND RECORDING MEDIUM

(71) Applicant: CASIO COMPUTER CO., LTD., Tokyo (JP)

(72) Inventor: Akira INOUE, Tokyo (JP)

(73) Assignee: CASIO COMPUTER CO., LTD., Tokyo (JP)

(21) Appl. No.: 18/456,929

(22) Filed: Aug. 28, 2023

(30) Foreign Application Priority Data
Aug. 29, 2022 (JP) 2022-135472

(51) Int. Cl. G06T 7/55; G06V 40/10

(52) U.S. Cl. CPC G06T 7/55; G06V 40/11; G06T 2207/10024; G06T 2207/10028; G06T 2207/30196; G06V 40/28

(57) ABSTRACT

A detecting method executed by at least one processor includes acquiring depth information related to depth of a reference surface of a component and a target object. The detecting method further includes deriving a distance from the reference surface to a representative point of the target object based on the depth information. The distance is along an approximate normal to the reference surface. The detecting method further includes detecting the target object as a detection target, upon the distance satisfying a predetermined distance condition.

### CROSS-REFERENCE TO RELATED APPLICATIONS

This application is based upon and claims the benefit of priority from the prior Japanese Patent Application No. 2022-135472, filed on Aug. 29, 2022, the entire contents of which are incorporated herein by reference.

### TECHNICAL FIELD

The present disclosure relates to a detecting method, a detecting device, and a recording medium.

### DESCRIPTION OF RELATED ART

Conventionally, there has been technology for detecting a gesture of an operator and controlling the operation of a device in response to the detected gesture. In this technology, a specific part (for example, a hand) of the operator's body that makes the gesture is detected as a detection target in an image of the operator. For example, a method of detecting the detection target making the gesture based on the difference between a background image taken in advance and a captured image of the operator is disclosed.

### SUMMARY OF THE INVENTION

The detecting method according to the present disclosure is executed by at least one processor and includes:
acquiring depth information related to depth of a reference surface of a component and a target object;
deriving a distance from the reference surface to a representative point of the target object based on the depth information, the distance being along an approximate normal to the reference surface; and
detecting the target object as a detection target, upon the distance satisfying a predetermined distance condition.

The detecting device according to the present disclosure includes at least one processor that:
acquires depth information related to depth of a reference surface of a component and a target object;
derives a distance related to the target object based on the depth information, the distance being from the reference surface to a representative point of the target object and along an approximate normal to the reference surface; and
detects the target object as a detection target, upon the distance derived in the deriving related to the target object satisfying a predetermined distance condition.

A non-transitory computer-readable recording medium according to the present disclosure stores a program that causes at least one processor to:
acquire depth information related to depth of a reference surface of a component and a target object;
derive a distance related to the target object based on the depth information, the distance being from the reference surface to a representative point of the target object and along an approximate normal to the reference surface; and
detect the target object as a detection target, upon the distance derived in the deriving related to the target object satisfying a predetermined distance condition.

### BRIEF DESCRIPTION OF DRAWINGS

The accompanying drawings are not intended as a definition of the limits of the invention but illustrate embodiments of the invention, and together with the general description given above and the detailed description of the embodiments given below, serve to explain the principles of the invention, wherein:

FIG. 1 is a schematic diagram of an information processing system;

FIG. 2 is a block diagram showing a functional structure of a detecting device;

FIG. 3 is a flowchart showing a control procedure in a device control process;

FIG. 4 is a flowchart showing a control procedure in a hand detection process;

FIG. 5 is a flowchart showing a control procedure in a hand detection process;

FIG. 6 is a diagram illustrating an example of a captured image;

FIG. 7 is a diagram illustrating a method of deriving a distance between an image display surface and a representative point of a hand;

FIG. 8 is a diagram illustrating a case where a left hand holding a screen and a right hand making a gesture are at equal distances from the imaging device;

FIG. 9 is a diagram illustrating a positional relationship between the screen and an operator in a modification example; and

FIG. 10 is a diagram illustrating an example of a captured image in the modification example.

### DETAILED DESCRIPTION

Hereinafter, one or more embodiments of the present invention will be described with reference to the drawings. However, the scope of the present invention is not limited to the disclosed embodiments.

<Summary of Information Processing System>

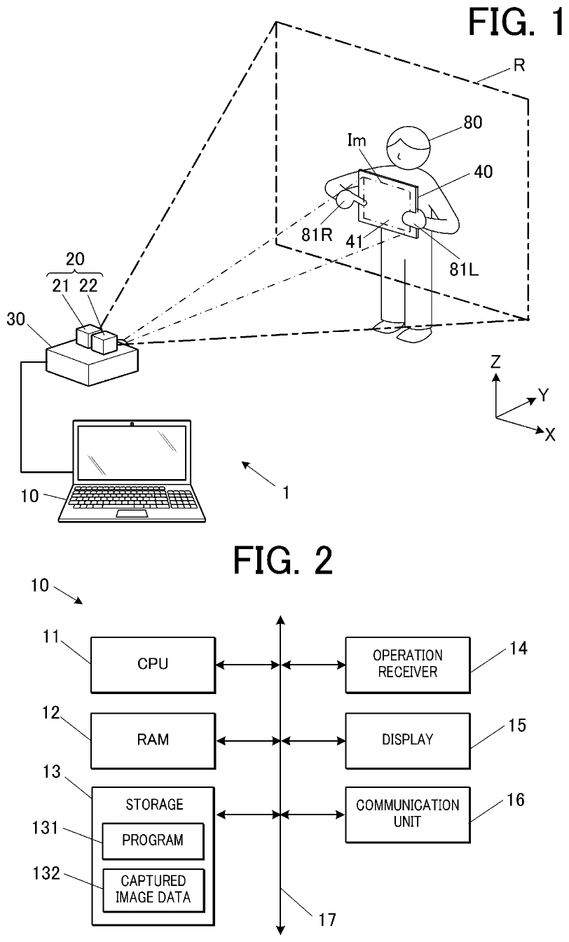

FIG. 1 is a schematic diagram of the information processing system 1 of the present embodiment.

The information processing system 1 includes a detecting device 10, an imaging device 20, and a projector 30. The detecting device 10 is connected to the imaging device 20 and the projector 30 by wireless or wired communication, and can send and receive control signals, image data, and other data to and from the imaging device 20 and the projector 30.

The detecting device 10 of the information processing system 1 is an information processing device that detects gestures made by an operator 80 (a subject, a person) with a hand(s) 81 (a target, a detection target) and controls the operation of the projector 30 (operation to project a projection image Im, operation to change various settings, and the like) depending on the detected gestures. The “hand 81” in the present application may be either the right hand 81R or the left hand 81L of the operator 80.

In detail, the imaging device 20 takes an image of the operator 80 located in front of the imaging device 20 and the hand 81 of the operator 80, and sends image data of the captured image 50 (see FIG. 6) to the detecting device 10. The detecting device 10 analyzes the captured image 50 from the imaging device 20, detects the hand 81 and a finger(s) of the operator 80, and determines whether or not the operator 80 has made the predetermined gesture with the hand 81. In the present embodiment, the gesture made by the operator 80 with the hand 81 is defined as a gesture including an orientation and movement of the finger(s) of the hand(s) 81. When the detecting device 10 determines that the operator 80 has made a predetermined gesture with the hand 81, it sends a control signal to the projector 30 and controls the projector 30 to perform an action in response to the detected gesture. This allows the operator 80 to intuitively perform an operation of switching the projection image Im being projected by the projector 30 to the next projection image Im by, for example, making a gesture with one finger (for example, an index finger) pointing to the right as viewed from the imaging device, and an operation of switching the projection image Im being projected to the previous projection image Im by making a gesture with the one finger pointing to the left.

In the following, the Z axis is perpendicular to the floor on which the operator 80 is standing. The +Z direction is the direction along the Z axis and vertically upward. The Y axis is parallel to the floor surface and parallel to the direction of projection by the projector 30 as viewed from the +Z direction. The X axis is perpendicular to the Y and Z axes. The +Y direction is the direction along the Y axis from the projector 30 toward the operator 80. The +X direction is the direction to the right along the X axis, as viewed from the projector 30 toward the operator 80.

In the present embodiment, the operator 80 holds the screen 40 (a component) with the hand 81. The projector 30 projects (displays) the projection image Im onto the image display surface 41 (reference surface) of this screen 40. Specifically, the operator 80 holds the screen 40 with the left hand 81L and gestures with the right hand 81R held in front of (−Y direction side of) the screen 40 to operate the projector 30. The screen 40 is a plate-like component. The image display surface 41 is the surface facing the imaging device 20 of the front surface and the back surface of the screen 40.

<Configuration of Information Processing System>

FIG. 2 is a block diagram showing the functional configuration of the detecting device 10.

The detecting device 10 includes a CPU 11 (Central Processing Unit), a RAM 12 (Random Access Memory), a storage 13 (a recording medium), an operation receiver 14, a display 15, a communication unit 16, and a bus 17. The parts of the detecting device 10 are connected to each other via the bus 17. The detecting device 10 is a notebook personal computer in the present embodiment, but may be, for example, a stationary personal computer, a smartphone, or a tablet device.

The CPU 11 is a processor that controls the operation of the detecting device 10 by reading and executing the program 131 stored in the storage 13 and performing various arithmetic operations. The CPU 11 corresponds to “at least one processor”. The detecting device 10 may have multiple processors (i.e., multiple CPUs), and the multiple processes performed by the CPU 11 in the present embodiment may be performed by the multiple processors. In this case, the multiple processors correspond the “at least one processor”. In this case, the multiple processors may be involved in a common process, or may independently perform different processes in parallel.

The RAM 12 provides the CPU 11 with memory space for work and stores temporary data.

The storage 13 is a non-transitory recording medium that can be read by the CPU 11 as a computer and stores the program 131 and various data. The storage 13 includes a non-volatile memory, such as a hard disk drive (HDD) and a solid state drive (SSD). The program 131 is stored in the storage 13 in the form of computer-readable program code. The storage 13 stores captured image data 132 relating to a color image and a depth image, etc., received from the imaging device 20 as data.

The operation receiver 14 has at least one of a touch panel superimposed on the display screen of the display 15, a physical button, a pointing device such as a mouse, and an input device such as a keyboard. The operation receiver 14 outputs operation information to the CPU 11 in response to input operations on the input device.

The display 15 includes a display device such as a liquid crystal display and causes the display device to display various items according to display control signals from the CPU 11.

The communication unit 16 is configured with a network card, communication module, or the like, and transmits data between the imaging device 20 and the projector 30 in accordance with a predetermined communication standard.

The imaging device 20 illustrated in FIG. 1 includes a color camera 21 and a depth camera 22.

The color camera 21 captures an imaging region R including the image display surface 41 of the screen 40, the operator 80, and their background, and generates color image data related to a two-dimensional color image of the imaging region R. The color image data includes color information of each pixel such as R (red), G (green), and B (blue).

The depth camera 22 captures the imaging region R including the image display surface 41 of the screen 40, the operator 80, and their background, and generates depth image data related to a depth image including depth information of the imaging region R. Each pixel in the depth image includes depth information related to the depth (distance from the depth camera 22 to a measured object) of the image display surface, the operator 80, and a background structure(s) (collectively referred to as the “measured object”). The depth camera 22 can be, for example, one that detects distance using the TOF (Time of Flight) method, or one that detects distance using the stereo method.

The color image data generated by the color camera 21 and the depth image data generated by the depth camera 22 are stored in the storage 13 of the detecting device 10 as the captured image data 132 (see FIG. 2).

In the present embodiment, the above color image and the depth image correspond to “captured images acquired by capturing the imaging region”.

The color camera 21 and the depth camera 22 of the imaging device 20 takes a series of images of the operator 80 and the screen 40 positioned in front of the imaging device 20 at a predetermined frame rate. The imaging device 20 in FIG. 1 includes the color camera 21 and the depth camera 22 separately, but is not limited to this configuration as long as each camera is capable of taking an image of the operator 80. For example, the color camera 21 and the depth camera 22 may be integrally installed.

The color camera 21 and the depth camera 22 need only be capable of capturing a region (angle of view) including at least the imaging region R. The angle of view captured by the color camera 21 and the angle of view captured by the depth camera 22 may be different. In the imaging region R where the angle of view captured by the color camera 21 and the angle of view captured by the depth camera 22 overlap, the pixels in the color image are mapped to the pixels in the depth image. As a result, when an arbitrary pixel in the color image is identified, the pixel corresponding to that pixel in the depth image can be identified. Therefore, depth information can be acquired for any pixel in the color image.

The projector 30 illustrated in FIG. 1 projects the projection image Im on the image display surface 41 (projection surface) of the screen 40 by emitting a highly directional projection light with an intensity distribution corresponding to the image data of the projection image Im. In detail, the projector 30 includes a light source, a display element such as a digital micromirror device (DMD) that adjusts the intensity distribution of light output from the light source to form a light image, and a group of projection lenses that focus the light image formed by the display element and project it as the projection image Im. The projector 30 changes the projection image Im to be projected or changes the settings (brightness, hue, and the like) related to the projection mode according to the control signal sent from the detecting device 10.

<Operation of Information Processing System>

The operation of the information processing system 1 is described next.

The CPU 11 of the imaging device 10 analyzes one or more color images and the depth images captured by the imaging device 20 to determine whether or not the operator 80 captured in the images has made a predetermined gesture with the hand 81. When the CPU 11 determines that the gesture has been made with the hand 81, it sends a control signal to the projector 30 to cause the projector 30 to perform an action in response to the detected gesture.

The gesture with the hand 81 is, for example, moving the finger in a certain direction (rightward, leftward, downward, upward, or the like) as viewed from the imaging device 20, moving the fingertip to draw a predetermined shape trajectory (circular or the like), changing the distance between tips of two or more fingers, bending and stretching of the finger(s), or the like. Each of these gestures is mapped to one action of the projector 30 in advance. For example, a gesture of turning the finger to the right may be mapped to an action of switching the current projection image Im to the next projection image Im, and a gesture of turning the finger to the left may be mapped to an action of switching the current projection image Im to the previous projection image Im. In this case, the projection image Im can be switched to the next/previous projection image by making a gesture of turning the finger to the right/left. The gesture of increasing/decreasing the distance between the tips of the thumb and index finger may be mapped to the action of enlarging/reducing the projection image Im, respectively. These are examples of mapping a gesture to an action of the projector 30, and any gesture can be mapped to any action of the projector 30. In response to user operation on the operation receiver 14, it may also be possible to change the mapping or to generate a new mapping between the gesture and the action of the projector 30.

When the operator 80 operates the projector 30 with the gesture of the hand 81, it is important to correctly detect the hand 81 in the image captured by the imaging device 20. This is because when the hand 81 cannot be detected correctly, the gesture cannot be recognized correctly, and operability will be severely degraded.

However, as illustrated in FIG. 1, when the projector 30 is used with the screen 40 held by the operator 80 with the hand 81, the hand holding the screen 40 (the left hand 81L in FIG. 1) may be erroneously detected as the hand 81 making the gesture. Due to the erroneous detection of the gesture that occurs in this case, the projector 30 performs an unintended action.

Therefore, in the present embodiment, using the depth information from the depth camera 22, a hand 81 that is not making a gesture such as the hand 81 holding the screen 40 is removed from the detection targets, and a hand 81 making a gesture, such as the hand 81 held in front of the screen 40 (on the side of the imaging device 20, −Y direction side), is appropriately detected as the detection target.

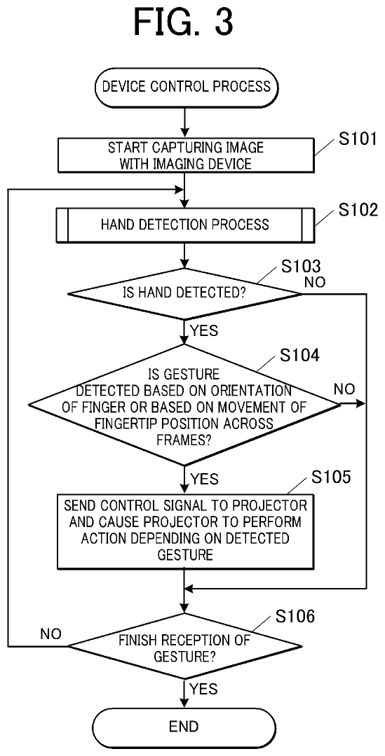

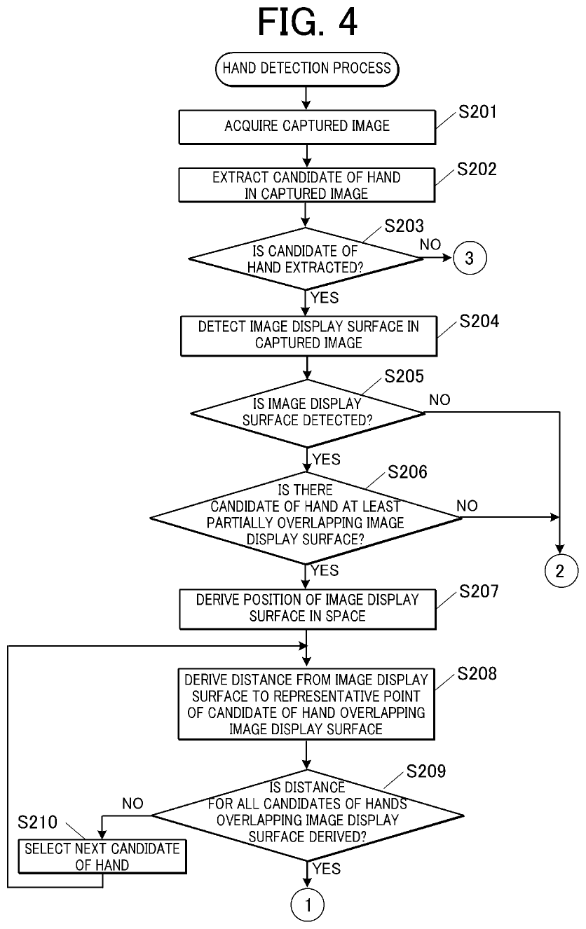

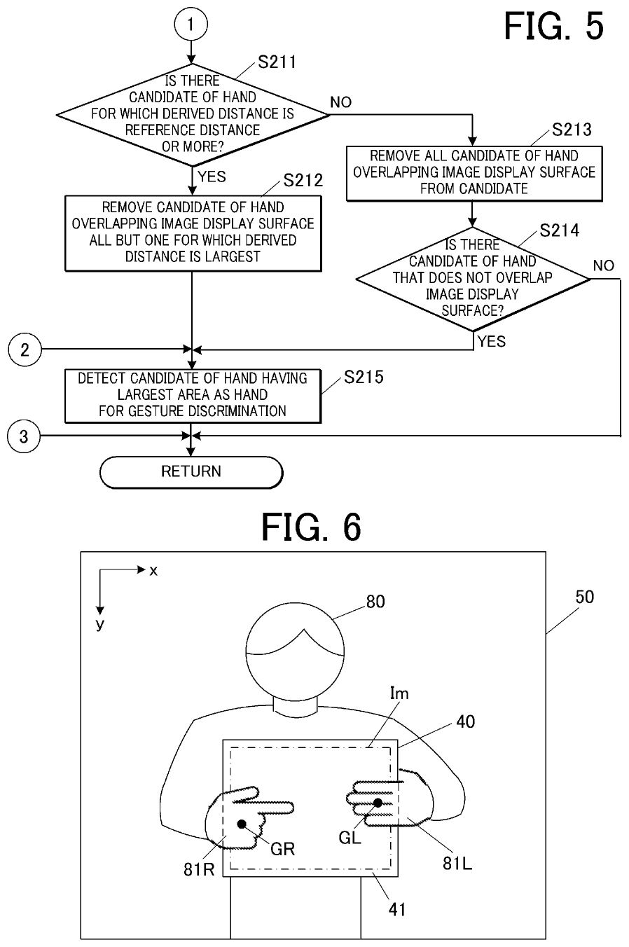

Referring to FIG. 3 to FIG. 8, the operation of the CPU 11 of the detecting device 10 to detect the hand 81 of the operator 80 and to detect a gesture with the hand 81 to control the action of the projector 30 are described below. The CPU 11 executes the device control process illustrated in FIG. 3 and the hand detection process illustrated in FIG. 4 and FIG. 5 to achieve the above actions.

FIG. 3 is a flowchart showing a control procedure in a device control process.

The device control process is executed, for example, when the detecting device 10, the imaging device 20, and the projector 30 are turned on and a gesture to operate the projector 30 is started to be received.

When the device control process is started, the CPU 11 sends a control signal to the imaging device 20 to cause the color camera 21 and the depth camera 22 to start capturing an image (Step S101). When an image is started to be captured, the CPU 11 executes the hand detection process (Step S102).

FIG. 4 and FIG. 5 are flowcharts showing the control procedure in the hand detection process.

When the hand detection process is started, the CPU 11 acquires the captured image 50 (the captured image data 132) of the operator 80 and the hand 81 (Step S201). The CPU 11 extracts a candidate of the hand region corresponding to the hand 81 (hereinafter simply referred to as a “candidate of the hand 81”) in the acquired captured image 50 (Step S202). The process of extracting the candidate of the hand 81 in the captured image 50 corresponds to the process of extracting the target object in the captured image 50.

FIG. 6 is a diagram illustrating an example of the captured image 50.

The captured image 50 is acquired by the imaging device 20 capturing the imaging region R illustrated in FIG. 2, and includes a color image and a depth image. FIG. 6 illustrates a color image of these images. As described above, each pixel in the color image is associated with the depth information of the corresponding pixel in the depth image. The x-axis and y-axis illustrated in FIG. 6 are the coordinate axes of an orthogonal coordinate system that represent the positions of the pixels in the captured image 50. The operator 80 holding the screen 40 with his left hand 81L is captured in the image 50 illustrated in FIG. 3. The operator 80 holds the right hand 81R in front of and apart from the screen 40 and makes a gesture of pointing the index finger in the right direction as viewed from the imaging device 20. In Step S202, the right hand 81R and the left hand 81L are extracted as candidates for the hand 81 from the captured image 50 illustrated in FIG. 3.

The method of extracting a candidate of the hand 81 from the captured image 50 in Step S202 is not particularly limited, but may be, for example, the following method. First, a thresholding process related to color is performed based on the color information of the color image to extract a skin color (the color of the hand 81) region(s) from the color image. Next, whether or not the extracted region each has a protrusion(s) corresponding to a finger(s) is determined. Of the extracted regions, the region(s) determined to have the protrusion corresponding to the finger is extracted as a candidate(s) of the hand 81.

The above method is an example, and the candidate of the hand 81 can be extracted by any method using at least one of the color image and the depth image. For example, when the position of the screen 40 in the Y direction is fixed such that the hand 81 of the operator 80 is defined to be located in a predetermined range (depth range) in the Y direction, a thresholding process related to depth may be performed on the region extracted by the above thresholding process of the color image, and the region capturing where the above depth range where hand 81 is located may be extracted.

The CPU 11 may generate a mask image representing the hand region corresponding to the extracted hand 81 and use the mask image data in subsequent processes. The mask image data is, for example, an image in which the pixel values of the pixels corresponding to the hand region are set to “1” and the pixel values of the pixels corresponding to the areas other than the hand region are set to “0”.

The CPU 11 determines whether or not a candidate of the hand 81 has been extracted in Step S202 (Step S203). If it is determined that a candidate of the hand 81 has been extracted (“YES” in Step S203), the CPU 11 detects (identifies) the image display surface 41 of the screen 40 in the captured image 50 (Step S204). The method of detecting the image display surface 41 is not particularly limited. For example, a planar rectangular region with a constant or continuously changing depth in the depth image may be extracted as the image display surface 41. Alternatively, a rectangular outline of the image display surface 41 (the screen 40) may be detected in the color image. Alternatively, predetermined signs may be provided at the four corners of the image display surface 41 (the screen 40) in advance, and the image display surface 41 may be detected based on the signs detected in the captured image 50. Alternatively, a predetermined sign(s) may be included in the projection image Im, and the image display surface 41 may be detected based on the sign(s) detected in the captured image 50.

The CPU 11 determines whether or not the image display surface 41 has been detected (Step S205). If it is determined that the image display surface 41 has been detected (“YES” in Step S205), the CPU 11 determines whether or not there is a candidate of the hand 81 in the captured image 50 that at least partially overlaps the image display surface 41 (Step S206). Here, the CPU 11 determines whether or not at least a part of the pixels in the candidate of the hand 81 (hand region) is within the rectangle range of the image display surface 41 in the xy-coordinate plane in the captured image 50. When the image display surface 41 is partially hidden by a hand 81 or the like as illustrated in FIG. 6, the rectangle outline of the image display surface 41 is complemented before the determination in Step S206. When only a part of a certain hand 81 overlaps the image display surface 41, the CPU 11 determines that the certain hand 81 overlaps the image display surface 41. In the example illustrated in FIG. 6, the right hand 81R and the left hand 81L are determined to be candidates of the hand 81 overlapping the image display surface 41 because a part of the right hand 81R and a part of the left hand 81L overlap the image display surface 41.

If it is determined that there is a candidate of the hand 81 that at least partially overlaps the image display surface 41 (“YES” in Step S206), the CPU 11 derives the position of the image display surface 41 in the space (Step S207). In Step S207, the CPU 11 first identifies the coordinates in the XYZ coordinate space of at least three of the four vertices of the image display surface 41. More specifically, the CPU 11 identifies the distance from the imaging device 20 to each of the vertices of the image display surface 41 based on the depth information of the portion corresponding to the extracted image display surface 41 in the depth image. The CPU 11 then derives the coordinates of the respective vertices in the XYZ coordinate space based on the identified distances and the positions of the vertices of the image display surface 41 in the color image or the depth image (positions in the XY coordinate plane). The CPU 11 then derives a plane equation representing the position of the image display surface 41 in the XYZ coordinate space based on the coordinates of the at least three vertices. The plane equation is expressed, for example, in the form “aX+by +cZ+d=0”.

Next, the CPU 11 derives the distance from the image display surface 41 to a representative point of the candidate of the hand 81 overlapping the image display surface 41 (Step S208).

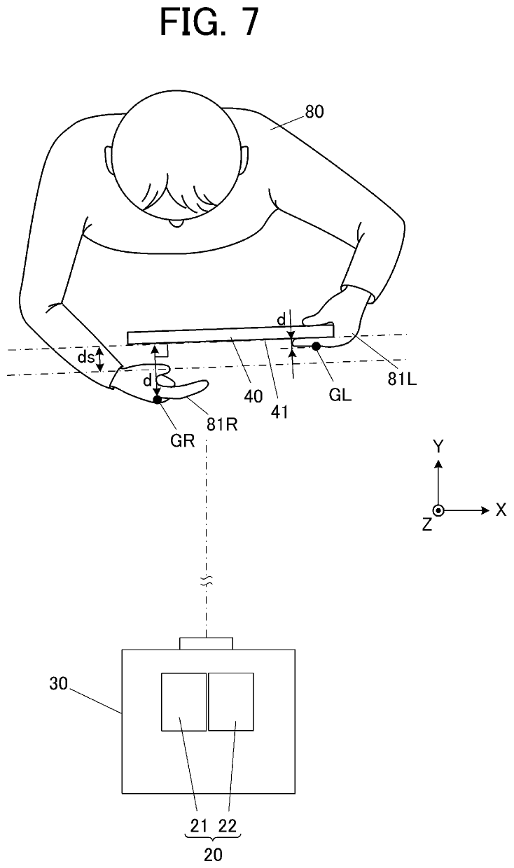

FIG. 7 is a diagram illustrating the method of deriving the distance between the image display surface 41 and the representative point of the hand 81.

FIG. 7 corresponds to a diagram of the operator 80 and the screen 40 illustrated in FIG. 1, viewed from the +Z direction. In FIG. 7, the image display surface 41 of screen 40 is parallel to the Z direction. However, even when the image display surface 41 is not parallel to the Z direction, the distance d can be derived in the following manner.

When the distance between the image display surface 41 and the representative point of the hand 81 is derived, first, the coordinate of the representative point of the hand 81 in the XYZ coordinate space is derived. In the present embodiment, the representative point of the hand 81 is the centroid of the portion of the hand 81 overlapping the image display surface 41 in the captured image 50 illustrated in FIG. 6. The centroid of the right hand 81R is the centroid GR, and the centroid of the left hand 81L is the centroid GL. Hereinafter, the centroid G is either the centroid GR or the centroid GL.

The centroid G of the hand 81 is a point on the surface of the hand 81 facing the imaging device 20 in the XYZ coordinate space, as illustrated in FIG. 7. The CPU 11 identifies the distance from the imaging device 20 to the centroid G based on the depth information of the pixel corresponding to the centroid G in the captured image 50. Based on the identified distance and the position of the centroid G in the color image or in the depth image, the CPU 11 derives the coordinate of the centroid G in the XYZ coordinate space. After deriving the coordinate of the centroid G, the CPU 11 uses the plane equation of the image display surface 41 to derive the distance d from the image display surface 41 to the centroid G of the hand 81 along a normal to the image display surface 41.

The normal may not be the exact normal to the image display surface 41. The normal to the image display surface 41 may be an approximate normal that is slightly inclined at an angle of ±10 degrees or less with respect to the exact normal, for example. In other words, the derived distance d may be along the approximate normal to the image display surface 41.

The representative point of the hand 81 is not limited to the centroid G of the hand 81. For example, the average depth of the pixels in the hand 81 (hand region) overlapping the image display surface 41 illustrated in FIG. 6 may be calculated, and the pixel with the depth closest to that average depth may be used as the representative point.

We now return to the description of FIG. 4. When the process of Step S208 is completed, the CPU 11 determines whether or not the distance d has been derived for all the candidates of the hand 81 overlapping the image display surface 41 (Step S209). If it is determined that the distance d has not been derived for at least one of the candidates of the hand 81 overlapping the image display surface 41 (“NO” in Step S209), the CPU 11 selects the next candidate of the hand 81 (Step S210) and derives the distance d for the next candidate of the hand 81 (Step S208).

If it is determined that the distance d has been derived for all the candidates of the hand 81 overlapping the image display surface 41 (“YES” in Step S209), the CPU 11 determines whether or not there is a candidate of the hand 81 for which the derived distance d satisfies a predetermined distance condition (Step S211 in FIG. 5). In the present embodiment, if the derived distance d is greater than or equal to a standard distance ds, it is determined that the distance d satisfies the distance condition. Here, the standard distance ds is set to be longer than the distance d between the centroid G of the hand 81 (the left hand 81L in FIG. 7) holding the screen 40 and the image display surface 41 as illustrated in FIG. 7, and is stored in the storage 13 in advance. Since the distance d of the hand 81 holding the screen 40 is about the thickness of a finger, the standard distance ds is longer than the thickness of a finger of a hand of a person (for example, the average thickness of a finger of a person is about 2.5 cm). To ensure that the hand 81 holding the screen 40 is removed from the detection target, the standard distance ds may be the sum of the average thickness of a finger of a person and a predetermined margin.

In the example illustrated in FIG. 7, while the distance d from the image display surface 41 to the centroid GR of the right hand 81R is determined to be greater than or equal to the standard distance ds, the distance d from the image display surface 41 to the centroid GL of the left hand 81L is determined to be less than the standard distance ds.

If it is determined that there is a candidate of the hand 81 for which the derived distance d is greater than or equal to the standard distance ds (“YES” in Step S211), the CPU 11 removes the candidates of the hand 81 overlapping the image display surface 41 all but one for which the derived distance d is the greatest (Step S212). As a result, the candidate of the hand 81 overlapping the image display surface 41 and whose distance d from the image display surface 41 is less than the standard distance ds (the hand 81 holding the screen 40) can be removed from the candidates. This also allows to limit the hand 81 used for gesture discrimination to one of the two or more hands 81 for which the derived distance d is greater than or equal to the standard distance ds. In the example illustrated in FIG. 7, of the two candidates of the hand 81 (the right hand 81R and the left hand 81L), the right hand 81R is the one for which the distance d is the greatest. Therefore, the hand 81 other than the right hand 81R, that is, the left hand 81L, is removed from the candidates.

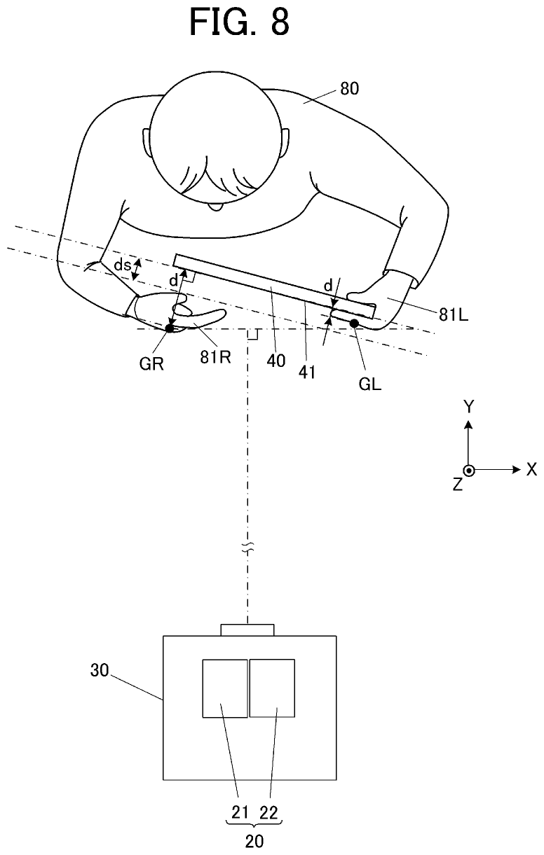

As a result of the determination of whether or not the distance d from the image display surface 41 is greater than or equal to the standard distance ds based on the distance d along the normal to the image display surface 41, it is possible to appropriately limit the candidate of the hand 81 regardless of the positional relationship between the imaging device 20 and the hand 81. For example, when the centroid GL of the left hand 81L holding the screen 40 and the centroid GR of the right hand 81R making the gesture are at equal distances from the imaging device 20 as illustrated in FIG. 8, it is possible to remove the left hand 81L from the candidates and leave the right hand 81R as a candidate.

When the process of Step S212 is completed, the CPU 11 detects the candidate of the hand 81 having the largest area in the captured image 50 of the candidate(s) of the hand 81 at that time as the hand 81 (detection target) for gesture discrimination (Step S215). The candidates of the hand 81 that do not overlap the image display surface 41 are also included in the target for determining the area in Step S215.

If it is determined in Step S211 that there is no candidate of the hand 81 for which the derived distance d is greater than or equal to the standard distance ds (“NO” in Step S211), the CPU 11 removes all the candidate(s) of the hand 81 that overlap the image display surface 41 from the candidates (Step S213). Then, the CPU 11 determines whether or not there is a candidate(s) of the hand 81 that does not overlap the image display surface 41 (Step S214). If it is determined that there is a candidate of the hand 81 that does not overlap the image display surface 41 (“YES” in Step S214), the CPU 11 performs the process in Step S215 described above.

If it is determined in Step S205 that no image display surface 41 has been detected (“NO” in Step S205) or if it is determined in Step S206 that there is no candidate of the hand 81 that at least partially overlaps the image display surface 41 (“NO” in Step S206), the CPU 11 also performs the process in Step S215 described above.

If the process of Step S215 is completed, if it is determined in Step S214 that there is no candidate of the hand 81 that does not overlap the image display surface 41 (“NO” in Step S214), or if it is determined in Step S203 that no candidate of the hand 81 has been extracted (“NO” in Step S203), the CPU 11 finishes the hand detection process and returns the process to the device control process in FIG. 3.

The CPU 11 may leave all the candidates of the hands 81 overlapping the image display surface 41 for which the derived distance d is greater than or equal to the standard distance ds (remove only the hand 81 for which the derived distance d is less than the standard distance ds) in Step S212, and may detect the candidate of the hand 81 having the largest area of the remaining candidate(s) of the hand 81 as the hand 81 for gesture discrimination in Step S215.

The CPU 11 detects the candidate of the hand 81 having the largest area as the hand 81 for gesture discrimination in step S215 above, but may determine the one hand 81 for gesture discrimination in other ways. For example, the CPU 11 may derive an index value for the possibility that the candidate is a hand 81 based on the shape of the fingers of the hand 81, etc., and detect the candidate of the hand 81 having the largest index value as the hand 81 for gesture discrimination.

When the hand detection process of Step S102 in FIG. 3 is completed, the CPU 11 determines whether or not the hand 81 for gesture discrimination has been detected in the hand detection process (Step S103). If it is determined that the hand 81 has been detected (“YES” in Step S103), the CPU 11 determines whether or not a gesture with the hand 81 of the operator 80 has been detected (Step S104) based on the orientation of the finger(s) of the hand 81 or the movement of the fingertip position across the multiple frames of the captured image 50. If it is determined that a gesture has been detected (“YES” in Step S104), the CPU 11 sends a control signal to the projector 30 to cause it to perform an action in response to the detected gesture (Step S105). The projector 30 receiving the control signal performs the action in response to the control signal.

If the process of Step S105 is completed, if it is determined in Step S103 that no hand 81 has been detected (“NO” in Step S103), or if it is determined in Step S104 that no gesture has been detected (“NO” in Step S104), the CPU 11 determines whether or not the information processing system 1 finishes receiving the gesture (Step S106). Here, the CPU 11 determines to finish receiving the gesture when, for example, an operation to turn off the power of the information processing device 10, the imaging device 20, or the projector 80 is performed.

If it is determined that the receiving of the gesture is not finished (“NO” in Step S106), the CPU 11 returns the process to Step S102 and executes the hand detection process to detect the hand 81 based on the captured image captured in the next frame period. A series of looping processes of Steps S102 to S106 is repeated, for example, at the frame rate of the capture with the color camera 21 and the depth camera 22 (that is, each time the color image and the depth image are generated).

If it is determined that the receiving of the gesture is finished (“YES” in Step S106), the CPU 11 finishes the device control process.

### Modification Example

Next, a modification example of the above embodiment will be described. In the following, differences from the above embodiment will be described. Configurations that are common to the above embodiment will be labeled with common reference signs and omitted from the description.

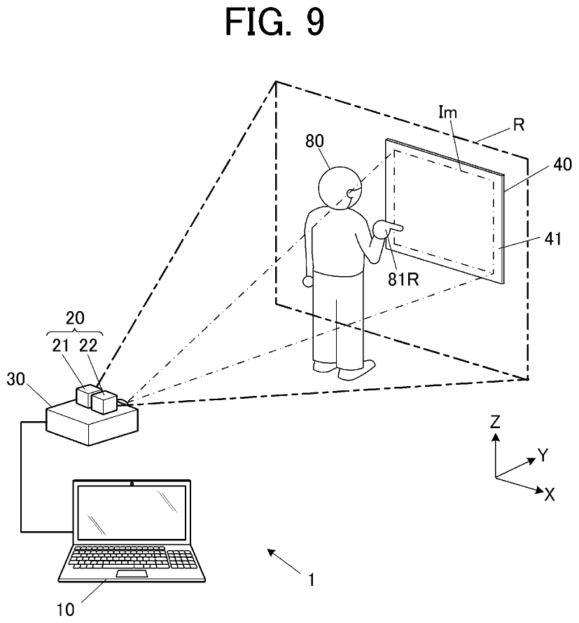

FIG. 9 is a diagram illustrating the positional relationship between the screen 40 and the operator 80 in the modification example.

In the present modification example, the screen 40 is hung on a wall, and the operator 80 is standing in front of the screen 40 (at the −Y side of the screen 40) and looks at the projection image Im projected on the screen 40. The operator 80 gestures with the right hand 81 R to operate the projector 30. The imaging region R captured by the imaging device 20 includes the screen 40 and at least the upper body of the operator 80.

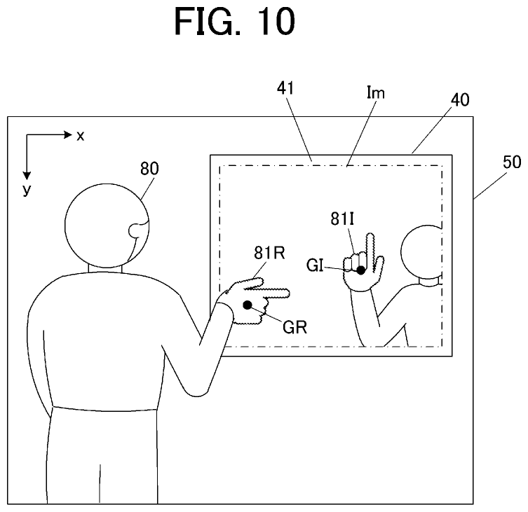

FIG. 10 is a diagram illustrating an example of the captured image 50 in the modification example.

The captured image 50 is an image of the imaging region R in FIG. 9 captured with the imaging device 20. The screen 40 and the operator 80 who is located on the image display surface 41 side of the screen 40 are captured in the captured image 50 illustrated in FIG. 10. The right hand 81R of the operator 80 overlaps the image display surface 41 in the captured image 50. The projection image Im projected on the image display surface 41 includes an image of a person and a hand 81I of the person.

In the hand detection process (FIG. 4) for such a captured image 50, the CPU 11 extracts the right hand 81R of the operator 80 and the hand 81I of the person in the projection image Im as the candidates for the hand 81 in Step S202. In Step S206, the CPU 11 determines the right hand 81R and the hand 81I as the candidates for the hand 81 overlapping the image display surface 41. Then, in Step S208, the CPU 11 derives the distance d from the image display surface 41 to the centroid GR of the right hand 81R and the distance d from the image display surface 41 to the centroid GI of the hand 81I. Then, in Step S211, the CPU 11 determines whether or not each of the derived distances d is equal to or greater than the standard distance ds.

The right hand 81R of the operator 80 is farther from the image display surface 41 by the standard distance ds or more. Therefore, the CPU 11 determines that the distance d of the right hand 81R is equal to or greater than the standard distance ds, thus leaving the right hand 81R as the candidate of the hand 81 for gesture discrimination. In this way, even when the operator 80 is positioned on the image display surface 41 side of the screen 40, the hand 81 of the operator 80 can be detected as the candidate of the hand 81 for gesture discrimination.

On the other hand, the hand 81I of the person in the projection image Im has its centroid GI in the XYZ coordinate space located on the image display surface 41. Therefore, the derived distance d is 0, and is determined to be less than the standard distance ds. Therefore, the hand 81I of the person included in the projection image Im is removed from the candidates of the hand 81 for gesture discrimination. Thus, when the projection image Im including the hand 81I is projected on the image display surface 41, the hand 81I can be appropriately removed from the candidates.

The positional relationship between the screen 40 and the operator 80 is not limited to that illustrated in FIG. 9. For example, the operator 80 may gesture with his hand 81 by holding the hand 81 between the screen 40 and the projector 30 while the projector 30 is positioned vertically above the screen 40 placed horizontally on a tabletop and projects the projection image Im vertically downward. Here, the screen 40 may be held by the operator 80 so as to be almost horizontal. In this case, the imaging device 20 can also be positioned vertically above the screen 40 so as to capture the screen 40 and the hand 81 of the operator 80.

<Effects>

As described above, the detecting method of the present embodiment is executed by the CPU 11 and includes: acquiring depth information related to the depth of the image display surface 41 (reference surface) of the screen 40 and the hand 81 (target object); deriving the distance d from the image display surface 41 to the centroid G (representative point) of the hand 81 along the approximate normal to the image display surface 41 based on the depth information; and detecting the hand 81 as the detection target, when the derived distance d related to the target object satisfies the predetermined distance condition. Thus, the hand(s) 81 that is not used in the gesture (for example, the hand 81 holding the screen 40, the hand 81I displayed as an image on the image display surface 41 of the screen 40, etc.) can be removed from the detection target. As a result, the hand 81 of the operator 80 making the gesture can be appropriately detected as the detection target. The determination based on the distance d along the approximate normal to the image display surface 41 makes it possible to appropriately limit the candidates of the hand 81, regardless of the positional relationship between the imaging device 20 and the hand 81. In addition, the above detection method does not require advanced information processing such as pattern matching or machine learning, and thus can be performed using a simply configured detecting device 10.

In the above-described detection method, the captured image 50 in which the image display surface 41 and the hand 81 are captured is acquired; and the distance d from the image display surface 41 to the centroid G of the hand 81 is derived based on the captured image 50 and the depth information. As a result, the hand 81 that is a candidate for the detection target can be easily and appropriately extracted from the captured image 50.

The above-described detection method further includes: acquiring a captured image 50 of the image display surface 41 and the hand 81; extracting the hand 81 that at least partially overlaps the image display surface 41 in the captured image 50; and deriving the distance d from the image display surface 41 to the centroid G of the extracted hand 81 based on the depth information. As a result, even the hand(s) 81 that is not used in the gesture but overlaps the image display surface 41 in the captured image 50 can be removed from the detection target, and the hand 81 of the gesturing operator 80 can be appropriately detected as the detection target.

The above-described detection method further includes determining that the distance d satisfies the distance condition upon the derived distance d being equal to or greater than the standard distance ds. As a result, it is possible to easily and appropriately remove the hand 81 that is not used in the gesture from the detection target.

The above-described detection method further includes, upon extraction of two or more hands 81, detecting one hand 81 of the two or more hands 81 as the detection target. The derived distance d related to the one hand 81 is the longest of the distance(s) d satisfying the distance condition and of the derived distances related to the respective two or more hands 81. As a result, it is possible to easily and appropriately limit the hand(s) 81 to one used for gesture discrimination.

In the above-described detection method, the representative point is the centroid G of the overlapping portion of the candidate of the hand 81 and the image display surface 41 in the captured image 50. As a result, the distance between the portion of the hand 81 overlapping the image display surface 41 and the image display surface 41 can be appropriately derived.

In the above-described detection method, the detection target is a hand 81 of a person, and the screen 40 is held by the hand 81 of a person. Thus, the hand 81 holding the screen 40 can be removed from the detection target, and the hand 81 with which the operator 80 gestures can be appropriately detected as the detection target.

In the above-described detection method of the modification example, the detection target is a hand 81 of a person, and the captured image 50 is an image of an imaging region R including the hand 81 of a person who is located on the side of the image display surface 41 of the screen 40. As a result, the hand 81 of the operator 80 who is gesturing on the image display surface 41 side of the screen 40 can be appropriately detected as a detection target.

In the above-described detection method, the reference surface of the screen 40 as a component is the image display surface 41 on which the projection image Im is projected (displayed). As a result, the hand 81I displayed as an image on the image display surface 41 of the screen 40 is removed from the detection target, and the hand 81 of the operator 80 making the gesture can be appropriately detected as the detection target.

The detecting device 10 of the embodiment acquires depth information related to the depth of the image display surface 41 of the screen 40 and the hand 81, derives, based on the depth information, the distance d from the image display surface 41 to the centroid G of the hand 81 along an approximate normal to the image display surface 41, and detects the hand 81 for which the derived distance d satisfies the predetermined distance condition as the detection target. This allows the hand(s) 81 that is not used in the gesture to be removed from the detection target, such that the hand 81 of the operator 80 that is used for the gesture is appropriately detected as the detection target. Also, it is possible to appropriately limit the candidate(s) of the hand 81, regardless of the positional relationship between the imaging device 20 and the hand 81. In addition, since advanced information processing such as pattern matching or machine learning is not required, the processing load on CPU 11 can be kept low.

The storage 13 of the embodiment is a non-transitory computer-readable recording medium that stores the program 131 that can be executed by the CPU 11. The program 131 stored in the storage 13 causes the CPU 11 to acquire depth information related to the depth of the image display surface 41 of the screen 40 and the hand 81, to derive, based on the depth information, the distance d from the image display surface 41 to the centroid G of the hand 81 along an approximate normal to the image display surface 41, and to detect the hand 81 for which the derived distance d satisfies the predetermined distance condition as the detection target. Thus, the hand(s) 81 that is not used in the gesture can be removed from the detection target, such that the hand 81 of the operator 80 that is used for the gesture is appropriately detected as the detection target. Also, it is possible to appropriately limit the candidate(s) of the hand 81, regardless of the positional relationship between the imaging device 20 and the hand 81. In addition, since advanced information processing such as pattern matching or machine learning is not required, the processing load on the CPU 11 can be kept low.

<Others>

The detecting method, the detecting device, and the program related to the present disclosure are exemplified in the description of the above embodiment, but are not limited thereto.

For example, the above embodiment is explained using an example in which the detecting device 10, the imaging device 20, and the projector 30 (the device to be operated by gestures) are separate, but this does not limit the present disclosure.

For example, the detecting device 10 and the imaging device 20 may be integrated into a single unit. As a specific example, the color camera 21 and the depth camera 22 of the imaging device 20 may be housed in a bezel of the display 15 of the detecting device 10.

Alternatively, the detecting device 10 and the device to be operated may be integrated into a single unit. For example, the functions of the detecting device 10 may be incorporated into the projector 30 in the above embodiment, and the processes performed by the detecting device 10 may be performed by a CPU (not shown in the drawings) of the projector 30. In this case, the projector 30 corresponds to the “detecting device”, and the CPU of the projector 30 corresponds to the “at least one processor”.

Alternatively, the imaging device 20 and the device to be operated may be integrated into a single unit. For example, the color camera 21 and the depth camera 22 of the imaging device 20 may be incorporated into the housing of the projector 30 in the above embodiment.

Alternatively, the detecting device 10, the imaging device 20, and the device to be operated may all be integrated into a single unit. For example, the color camera 21 and the depth camera 22 are housed in the bezel of the display 15 of the detecting device 10 as the device to be operated, and the detecting device 10 may be configured such that its actions are controlled by gestures made by the operator 80 with the hand 81 (finger 82).

The operator 80 is not limited to a person, but can also be a robot, an animal, or the like.

In the above embodiment, the screen 40 is exemplified as the “component” and the image display surface 41 (projection surface) on which the projection image Im is projected is exemplified as the “reference surface,” but these are not intended to limit the present disclosure.

For example, the “component” may be a display device such as a liquid crystal display, and the “reference surface” may be an image display surface of the display device.

The “component” may be a plate-like component held by the operator 80 in a position to serve as a background of the hand 81 to facilitate detection of gestures with the hand 81. In this case, the surface of the plate-like component on the side of the imaging device 20 corresponds to the “reference surface”.

In the above embodiment, the gesture made by the operator 80 with the hand 81 is a gesture including orientation or movement of the finger(s) of the hand(s) 81, but is not limited to this. The gesture made by the operator 80 with the hand 81 may be, for example, a gesture made by the movement of the entire hand 81.

The gesture of touching the image display surface 41 with a fingertip may also be used. Even when the image display surface 41 is directly touched with a fingertip in this way, the centroid G of the hand 81 (a portion at the back of the hand) is usually at least a standard distance ds from the image display surface 41. Therefore, the candidate of the hand 81 to be the detection target can be appropriately left by the method of the above embodiment. The detection of the gesture may be accompanied by a determination of whether or not the positional relationship between the fingertip and the image display surface 41 changes over a plurality of frames.

In the above embodiment, the distance d from the image display surface 41 to the centroid G (representative point) of the hand 81 illustrated in FIG. 7 was derived based on the depth information of the depth image captured by the depth camera 22. However, the depth information used to derive the distance d is not limited to be acquired by the depth camera 22. For example, a distance-deriving camera that captures the operator 80 and the screen 40 from above (in the +Z direction of) the operator 80 may be provided. The depth information related to the depth of the hand 81 can be obtained from the captured image by the distance-deriving camera to derive the distance d. When the hand 81 and the screen 40 in the captured image by the distance-deriving camera are respectively mapped to the hand 81 and the screen 40 in the captured image by the imaging device 20, it is possible to specify the position from which the distance d is derived in the captured image by the distance-deriving camera.

When the depth information of the image display surface 41 (reference surface) of the screen 40 and the hand 81 (target object) can be acquired, the hand 81 as the detection target can be detected based on the depth information even without acquisition of the captured image 50 illustrated in FIG. 6, etc. In other words, when the depth information can be acquired independently from the captured image 50, the acquisition of the captured image 50 may be omitted. In this case, the device used to acquire the depth information may be the depth camera 22 of the above embodiment or a measuring device such as a millimeter wave radar or an optical distance-measuring device.

In the example described in the above embodiment, the entire image display surface 41 of the screen 40 is included in the imaging region R, but the present disclosure is not limited to this. Only a portion of the image display surface 41 may be included in the imaging region R. In other words, only a portion of the image display surface 41 may be captured in the captured image 50.

The image display surface 41 is not limited to a flat surface, but may be curved. Also in this case, the position of the curved image display surface 41 in space is derived based on the depth information, and the derived shortest distance from the curved image display surface 41 to the representative point of the hand 81 can be determined as the distance d.

In the above description, examples of the computer-readable recording medium storing the programs of the present disclosure are HDD and SSD of the storage 13, but are not limited to these examples. Other examples of the computer-readable recording medium include a flash memory, a CD-ROM, and other information storage media. Further, as a medium to provide data of the program(s) of the present disclosure via a communication line, a carrier wave can be used.

It is of course possible to change the detailed configuration and operation of each part of the detecting device 10, the imaging device 20, and the projector 30 in the above embodiments to the extent not to depart from the purpose of the present disclosure.

Although some embodiments of the present disclosure have been described in detail, the present disclosure is not limited to the disclosed embodiments but includes the scope of the present disclosure that is described in the claims and the equivalents thereof.

1. A detecting method executed by at least one processor, comprising:
acquiring depth information related to depth of a reference surface of a component and a target object;
deriving a distance from the reference surface to a representative point of the target object based on the depth information, the distance being along an approximate normal to the reference surface; and
detecting the target object as a detection target, upon the distance satisfying a predetermined distance condition.

2. The detecting method according to claim 1, further comprising:
acquiring a captured image of the reference surface and the target object,
wherein the deriving includes deriving the distance based on the captured image and the depth information.

3. The detecting method according to claim 1, further comprising:
acquiring a captured image in which the reference surface and the target object are captured; and
extracting the target object in the captured image, at least a part of the target object overlapping the reference surface,
wherein the deriving includes deriving the distance based on the depth information, the distance being from the reference surface to the representative point of the target object that is extracted in the extracting.

4. The detecting method according to claim 1, further comprising:
determining that the distance satisfies the distance condition upon the distance that is derived in the deriving being greater than or equal to a standard distance.

5. The detecting method according to claim 1,
wherein, upon the target object including two or more target objects, the deriving includes deriving distances from the reference surface to respective representative points of the two or more target objects, and
wherein the detecting includes detecting the target object as the detection target, the distance from the reference surface to the representative point of the target object being a longest of the distances that satisfy the distance condition.

6. The detecting method according to claim 2,
wherein the representative point is a centroid of a portion of a candidate of the detection target that overlaps the reference surface in the captured image.

7. The detecting method according to claim 1,
wherein the detection target is a hand of a person, and
wherein the component is held by the hand.

8. The detecting method according to claim 2,
wherein the detection target is a hand of a person, and
wherein the captured image is an image of an imaging region including the hand of the person who is located on a side of the reference surface of the component.

9. The detecting method according to claim 1,
wherein the reference surface of the component is an image display surface on which an image is displayed.

10. The detecting method according to claim 1, further comprising:
extracting a planar rectangular region with a constant depth or a continuously changing depth as the reference surface based on the depth information.

11. The detecting method according to claim 1, further comprising:
acquiring a captured image of the reference surface of the component and the target object; and
identifying the reference surface based on a position of a sign in the captured image, the sign being at a predetermined position of the component.

12. The detecting method according to claim 1, further comprising:
acquiring a captured image of the reference surface and the target object; and
identifying the reference surface based on a position of a sign in the captured image, the sign being at a predetermined position in an image displayed on the reference surface.

13. A detecting device comprising at least one processor that:
acquires depth information related to depth of a reference surface of a component and a target object;
derives a distance related to the target object based on the depth information, the distance being from the reference surface to a representative point of the target object and along an approximate normal to the reference surface; and
detects the target object as a detection target, upon the distance derived in the deriving related to the target object satisfying a predetermined distance condition.

14. A non-transitory computer-readable recording medium storing a program that causes at least one processor to:
acquire depth information related to depth of a reference surface of a component and a target object;
derive a distance related to the target object based on the depth information, the distance being from the reference surface to a representative point of the target object and along an approximate normal to the reference surface; and
detect the target object as a detection target, upon the distance derived in the deriving related to the target object satisfying a predetermined distance condition.
